(19) United States
(12) Patent Application Publication
(10) Pub. No.: US 2026/0360678 A1
(43) Pub. Date: Nov. 12, 2026

(54) SYSTEMS AND METHODS FOR ALTERNATING STANDARDS FOR SAMPLE DEMULTIPLEXING

(71) Applicant: DH Technologies Development Pte. Ltd., Singapore (SG)

(72) Inventors: Chang LIU, Richmond Hill (CA); Gordana IVOSEV, Etobicoke (CA); Stephen TATE, Barrie (CA)

(73) Assignee: DH Technologies Development Pte. Ltd., Singapore (SG)

(21) Appl. No.: 19/123,819

(22) PCT Filed: Oct. 26, 2023
(86) PCT No.: PCT/IB2023/060829

§ 371 Date: Apr. 24, 2025

Related U.S. Application Data
(60) Provisional application No. 63/381,001, filed on Oct. 26, 2022.

(51) Int. Cl. H01J 49/00

(52) U.S. Cl. CPC H01J 49/0036

(57) ABSTRACT

A method and system of data acquisition for a mass analyzer, the method including providing a plurality of samples, each sample including a target analyte, adding a first internal standard to a first predetermined number of samples, the first internal standard including a first known analyte, adding a second internal standard to a second predetermined number of samples, the second internal standard including a second known analyte, the second internal standard being different than the first internal standard, receiving each sample at the mass analyzer, generating a trace for the plurality of samples, and determining at least one of a peak intensity and a peak position for the target analyte based on the generated trace.

### CROSS-REFERENCE TO RELATED APPLICATION

This application is being filed on Oct. 26, 2023, as a PCT International Patent Application that claims priority to and the benefit of U.S. Provisional Patent Application No. 63/381,001, filed on Oct. 26, 2022, which is hereby incorporated by reference in its entirety.

### BACKGROUND

Acoustic Ejection Mass Spectrometry (AEMS) is a high-throughput analytical platform, where nano-liter sized droplets, or samples, are ejected acoustically from a sample well plate in a non-contact manner, and captured in an open port interface (OPI). The sample is diluted and transferred from the OPI to a mass spectrometer (MS) for analysis. Although most applications have a throughput frequency, or number of samples per second, of about one sample per second, or about 1 Hz, some applications require higher throughput frequencies such as 2.5 Hz or greater, or more generally in a range of 1 Hz to 3 Hz.

### SUMMARY

In one aspect, the technology relates to method of data acquisition for a mass analyzer, the method including providing a plurality of samples, each sample including a target analyte, adding a first internal standard to a first predetermined number of samples, the first internal standard including a first known analyte, adding a second internal standard to a second predetermined number of samples, the second internal standard including a second known analyte, the second internal standard being different than the first internal standard, receiving each sample at the mass analyzer, generating a trace for the plurality of samples, and determining at least one of a peak intensity and a peak position for the target analyte based on the generated trace.

In an example of the above aspect, providing the plurality of samples includes providing each one of the plurality of samples in a well of a well plate. In another example, each of the first internal standard and the second internal standard has a known intensity at a given time, and has a known intensity for a given mass-to-charge ratio. In a further example, the first predetermined number of samples is different from the second predetermined number of samples. In other examples, adding the first internal standard includes adding the first internal standard in a first predetermined pattern of samples corresponding to the first predetermined number of samples. For example, adding the second internal standard includes adding the second internal standard in a second predetermined pattern of samples corresponding to the second predetermined number of samples. As another example, the first predetermined pattern is different from the second predetermined pattern. In yet another example, the first predetermined pattern and the second predetermined pattern share at least one sample.

In other examples of the above aspect, at least one of the plurality of samples includes the target analyte and the first internal standard. In another example, each one of the plurality of samples includes the target analyte and the first internal standard. In other examples, at least one of the plurality of samples includes the target analyte, the first internal standard and the second internal standard. In a further example, generating the trace for the plurality of samples includes generating a single combined trace for the plurality of samples. In another example, generating the trace includes detecting a plurality of signals, each signal including a peak position and peak intensity of the target analyte and at least one of a peak position and peak intensity of the first internal standard and a peak position and peak intensity of the second internal standard.

In yet another example of the above aspect, determining the peak intensity for the target analyte based on the generated trace includes comparing the peak intensity of the target analyte for a given sample to a peak intensity of the first internal standard present in the given sample. In another example, comparing the peak intensity of the target analyte for a given sample to a peak intensity of the first internal standard present in the given sample includes determining a peak intensity for the first internal standard, determining a ratio of a peak height of the target analyte and a peak height of the first internal standard, and determining the peak intensity for the target analyte based on the determined ratio and the determined peak intensity for the first internal standard. In another example, determining the ratio of the peak height of the target analyte and the peak height of the first internal standard includes determining a baseline of the peak of the second internal standard, and calculating the ratio of the peak height of the target analyte and the peak height of the first internal standard using the baseline of the peak of the second internal standard as a reference point.

In other examples of the above aspect, determining the peak position for the target analyte based on the generated trace includes determining a start time for a peak of the second internal standard, and determining the peak position of the target analyte as a relative position of the peak with respect to the determined start time for the peak of the second internal standard. In a further example, the method further includes adjusting one or more operating parameters of the mass analyzer based on the start time of the peak of the second internal standard. In yet another example, providing plurality of samples includes providing each of the plurality of samples in a well of a well plate, and adding the second internal standard includes adding the second internal standard to regularly spaced wells of the well plate. In other examples, the method further includes adding a third internal standard in a third predetermined number of wells of the well plate, the third standard including a third known analyte. In examples, the first internal standard, the second internal standard and the third standard are added to alternating wells of the plurality of wells.

In another aspect, the technology relates to a sample analyzing system that includes a sample receiver; a mass analysis device fluidically coupled to the sample receiver; a processor operatively coupled to the sample receiver and to the mass analysis device; and a memory coupled to the processor, the memory storing instructions that, when executed by the processor, perform a set of operations. In one aspect, the set of operations includes providing, at the sample receiver, a plurality of samples, each sample including a target analyte, adding a first internal standard to a first predetermined number of samples, the first internal standard including a first known analyte, adding a second internal standard to a second predetermined number of samples, the second internal standard including a second known analyte, the second internal standard being different than the first internal standard, receiving each sample at the mass analyzer, generating, at the mass analysis device, a trace for the plurality of samples, and determining, via the processor, at least one of a peak intensity and a peak position for the target analyte based on the generated trace.

In another example of the above aspect, the sample analyzing system includes at least one of an acoustic ejector, an ionization chamber, and a mass spectrometer. For example, the sample receiver includes an open port interface. In yet another example, sample analyzing system further includes a well plate including a plurality of wells, each well including one of the plurality of samples and at least one of the first internal standard and the second internal standard. In other examples, the sample analyzing system further includes a non-contact sample ejector; wherein the set of operations includes receiving each sample by introducing, with the non-contact sample ejector, each sample from the well plate into the sample receiver. For example, the non-contact sample ejector includes an acoustic droplet ejector. In another example, the sample analyzing system further includes at least one of a matrix-assisted laser desorption interface and a pneumatic nebulizer interface.

In other examples of the above aspect, each of the first internal standard and the second internal standard has a known intensity at a given time, and has a known intensity for a given mass-to-charge ratio. In another example, the first predetermined number of samples is different from the second predetermined number of samples. In other examples, the set of instructions includes adding the first internal standard by adding the first internal standard in a first predetermined pattern of samples corresponding to the first predetermined number of samples. In yet another example, the set of instructions includes adding the second internal standard by adding the second internal standard in a second predetermined pattern of samples corresponding to the second predetermined number of samples. For example, at least one of the plurality of samples includes the target analyte and the first internal standard. In another example, each one of the plurality of samples includes the target analyte and the first internal standard. In yet another example, at least one of the plurality of samples includes the target analyte, the first internal standard and the second internal standard. In a further example, wherein the set of instructions includes generating the trace for the plurality of samples by generating a single combined trace for the plurality of samples.

In other examples of the above aspect, the set of instructions includes generating the trace by detecting a plurality of signals, each signal including a peak position and peak intensity of the target analyte and at least one of a peak position and peak intensity of the first internal standard and a peak position and peak intensity of the second internal standard. In another example, the set of instructions includes determining the peak intensity for the target analyte based on the generated trace by comparing the peak intensity of the target analyte for a given sample to a peak intensity of the first internal standard present in the given sample. In further examples, the set of instructions includes comparing the peak intensity of the target analyte for a given well to a peak intensity of the first internal standard present in the given well by determining a peak intensity for the first internal standard, determining a ratio of a peak height of the target analyte and a peak height of the first internal standard, and determining the peak intensity for the target analyte based on the determined ratio and the determined peak intensity for the first internal standard.

In further examples of the above aspect, the set of instructions includes determining the ratio of the peak height of the target analyte and the peak height of the first internal standard by determining a baseline of the peak of the second internal standard, and calculating the ratio of the peak height of the target analyte and the peak height of the first internal standard using the baseline of the peak of the second internal standard as a reference point. In an examples, the set of instructions includes wherein determining the peak position for the target analyte based on the generated trace by determining a start time for a peak of the second internal standard, and determining the peak position of the target analyte as a relative position of the peak with respect to the determined start time for the peak of the second internal standard. In yet further example, the set of instructions further includes adjusting one or more operating parameters of the mass analyzer based on the start time of the peak of the second internal standard.

In another example of the above aspect, the sample analyzing system further includes an ionization element, wherein the set of operations further includes ionizing the received sample by the ionization element towards the mass analysis device. For example, the mass analysis device includes at least one of a differential mobility spectrometer (DMS), a mass spectrometer (MS), and a DMS/MS. In another example, a frequency of ejection of the first sample and the second sample at the sample receiver is greater than 1 Hz, for example in a range of 1 Hz to 3 Hz. In yet another example, the well plate includes one of 384 wells and 1536 wells.

In other examples of the above aspect, the second predetermined number of samples is inversely proportional to a throughput frequency of the mass analyzer. In another example, the set of instructions further includes adding a third internal standard in a third predetermined number of samples, the third standard including a third known analyte.

### BRIEF DESCRIPTION OF THE DRAWINGS

FIG. 1 is a schematic view of an example system combining acoustic droplet ejection (ADE) with an open port interface (OPI) sampling interface and electrospray ionization (ESI) source.

FIG. 2 is a schematic diagram illustrating operation of another particular example system in accordance with various embodiments described herein.

FIGS. 3A and 3B depict profiles of mass spectrometry data acquisition at different frequencies, in accordance with various embodiments described herein.

FIGS. 4A-4E depict a deconvolution of low-throughput and high-throughput data acquisition traces with internal standards, according to various examples of the disclosure.

FIGS. 5A-5C depict low-throughput and high-throughput data acquisition traces with internal standards, according to various examples of the disclosure.

FIG. 6 is a flow chart illustrating an example method for operating a high-throughput mass analyzer using internal standards, in accordance with various examples of the disclosure.

FIG. 7 depicts a block diagram of a computing device.

### DETAILED DESCRIPTION

Aspects of the technology described herein are performed on sample portions ejected or otherwise provided from a sample source. For example, the sample portions may be droplets, gels, solids, and the like. As another example, the sample source may be or may include a reservoir, a well, a container, and the like, and each sample source may include a plurality of sample portions that are similar or identical to each other.

For example, the sample portion is a droplet and the sample source is the well that contains the droplet as well as many other droplets. Herein, the term “sample” may be used interchangeably to describe both a sample contained in a sample source as well as a portion of that sample that is ejected from the sample source. Various types of sampling systems and ionization devices are described herein.

Acoustic Ejection Mass Spectrometry (AEMS) is a high-throughput analytical platform, where nano-liter sized droplets, or samples, are ejected acoustically from a sample well plate in a non-contact manner, and captured in an open port interface (OPI). The sample is diluted and transferred from the OPI to a mass spectrometer (MS) for analysis. Although an ejection may generate a one-second baseline wide peak on the standard system setup, which determines the analytical throughput to one well every second, or ~1 Hz, other types of ejection may generate a throughput frequency that is higher than 1 Hz such as, e.g., throughput frequencies in a range of 1Hz to 3 Hz, or throughput frequencies that are higher than 2.5 Hz or 3 Hz. Although the 1 Hz speed has been significantly faster than the routine LC-MS or flow-injection-MS, there are needs for even faster throughput for some assays.

Various examples of the current disclosure include the use of one or more internal standards to facilitate sample identification and baseline separation of the trace of an unknown analyte, also referred to herein as a target analyte. In examples, one or more internal standards, which are known analytes, are added to the unknown or target analyte in the same sample source. For example, a known analyte is an analyte which chemical formula is known and for which the amount and/or concentration is known.

In various examples, an advantage of adding one or more internal standards to the target analyte is to ensure that there is a known control analyte in every sample source or well, or in every second (or third, or fourth, etc.) sample source or well. Having such internal standard may result in a trace with baseline separated or easily deconvolved peaks for at least some of the internal standards. From such a trace, it may be possible to calculate with sufficient accuracy the position of the peaks of the unknown analyte.

For example, because the internal standard(s) can have baseline separated peaks, it may be possible to use these baseline-separated peaks to estimate the intensity of the peaks of target analyte as well as the start time and end time of the peak of the target analyte without having to resort to quantitative deconvolution of the trace by numerical optimization. In examples, estimating the peak of the target analyte based on the peaks of the known internal standards is more accurate than resorting to quantitative deconvolution of the trace by numerical optimization. In various examples, the traces of one or more internal standards may thus be used to model the peak shape of the unknown analyte.

### Ionization Devices

Although the sample ionization process is described above in the context of AEMS using OPI and ESI, other techniques of generating ionized samples may be used according to various examples of this disclosure. For example, ionized samples may be generated by desorption electrospray ionization (DESI), which is a combination of ESI and desorption ionization (DI) methods. In DESI, ionization takes place by directing an electrically charged mist to the sample surface that is a few millimeters away. The electrospray mist is pneumatically directed at the sample, thus forming splashed droplets that carry desorbed, ionized analytes. After ionization, the ions travel through air into the atmospheric pressure interface which is connected to the mass spectrometer.

Another ionization technique may include matrix-assisted laser desorption ionization (MALDI), which is an ionization technique that uses a laser energy absorbing matrix to create ions from large molecules with minimal fragmentation. In MALDI, a laser is fired at the matrix crystals in the dried-droplet spot. The matrix absorbs the laser energy; the matrix is desorbed and ionized (by addition of a proton) by this event. The hot plume produced during ablation contains many species: neutral and ionized matrix molecules, protonated and deprotonated matrix molecules, matrix clusters and nanodroplets.

Other ionization techniques may include rapid-fire mass spectrometry, liquid atmospheric pressure (LAP) MALDI, pneumatic ESI (which generates ions for mass spectrometry using electrospray by applying a high voltage to a liquid to produce an aerosol), and electron ionization (EI). EI may also be referred to as electron impact ionization or electron bombardment ionization, and is an ionization method in which energetic electrons interact with solid or gas phase atoms or molecules to produce ions. Any of the above techniques, as well as others that can perform sample ionization, may be used in examples of this disclosure.

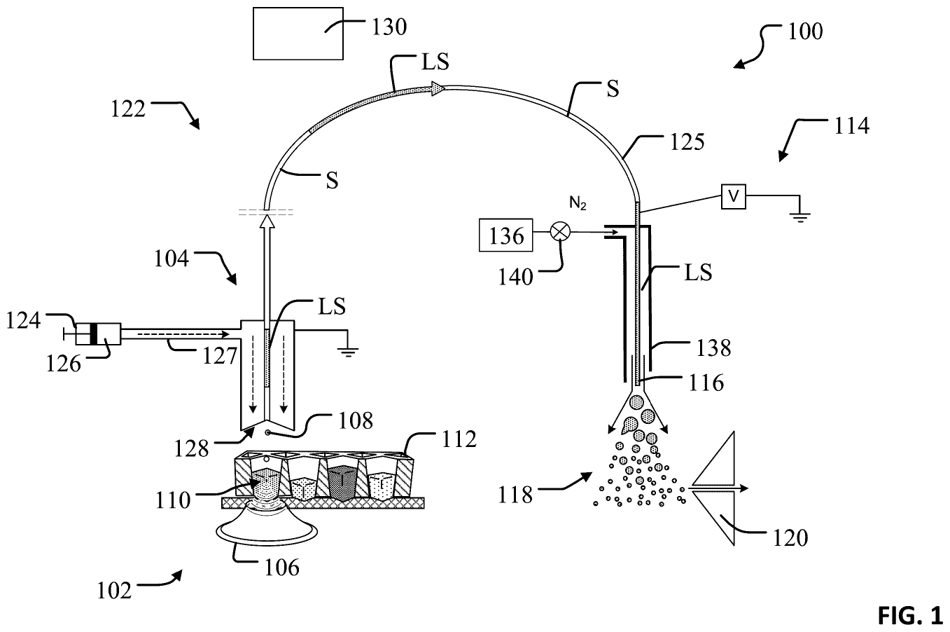

For illustrative purposes, FIG. 1 is a schematic view of an example system 100 combining an acoustic droplet ejection (ADE) 102 with an OPI sampling interface 104 and an ESI source 114, along with a mass spectrometer (MS) 120. Such a system 100 may be referred to as an acoustic ejection mass spectrometry (AEMS) system 100. The AEMS system 100 may include a mass analysis instrument such MS 120 for ionizing and mass analyzing analytes received within an open end of the sampling OPI 104. Such a system 100 is described, for example, in U.S. Pat. No. 10,770,277, the disclosure of which is incorporated by reference herein in its entirety. The ADE 102 includes an acoustic ejector 106 that is configured to eject a droplet or sample 108 from a reservoir 110 of a well plate 112 into the open end of sampling OPI 104. As shown in FIG. 1, the example system 100 generally includes the sampling OPI 104 in liquid communication with the ESI source 114 for discharging a liquid containing one or more sample analytes (e.g., via electrospray electrode 116) into an ionization chamber 118, and a mass analyzer detector (e.g., a MS depicted generally at 120) in communication with the ionization chamber 118 for downstream processing and/or detection of ions generated by the ESI source 114. Due to the configuration of the nebulizer nozzle 138 and electrospray electrode 116 of the ESI source 114, samples ejected therefrom are transformed into small-volume liquid droplets flying in a gas. A liquid handling system 122 (e.g., including one or more pumps 124 and one or more transfer conduits 125) provides for the flow of liquid from a reservoir 126 to the sampling OPI 104 and from the sampling OPI 104 to the ESI source 114. As ESI source 114 allows for the formation of multiple charged ions and are, therefore, more applicable to a variety of applications, they are described within the application for consistency. The technologies described herein, however, may also be utilized for systems that incorporate a plurality of atmospheric pressure chemical ionization (APCI) sources.

In FIG. 1, the reservoir 126 (e.g., containing a liquid, desorption solvent, a sample to be tested, etc.) can be fluidically coupled to the OPI 104 via a supply conduit 127 through which the liquid can be delivered at a selected volumetric rate by the pump 124 (e.g., a reciprocating pump, a positive displacement pump such as a rotary, gear, plunger, piston, peristaltic, diaphragm pump, or other pump such as a gravity, impulse, pneumatic, electrokinetic, and centrifugal pump), all by way of non-limiting example. As discussed in greater detail below, the flow of liquid into and out of the sampling OPI 104 occurs within a sample space accessible at the open end such that one or more droplets or samples 108 can be introduced into the liquid boundary 128 at the sample tip and subsequently delivered to the ESI source 114.

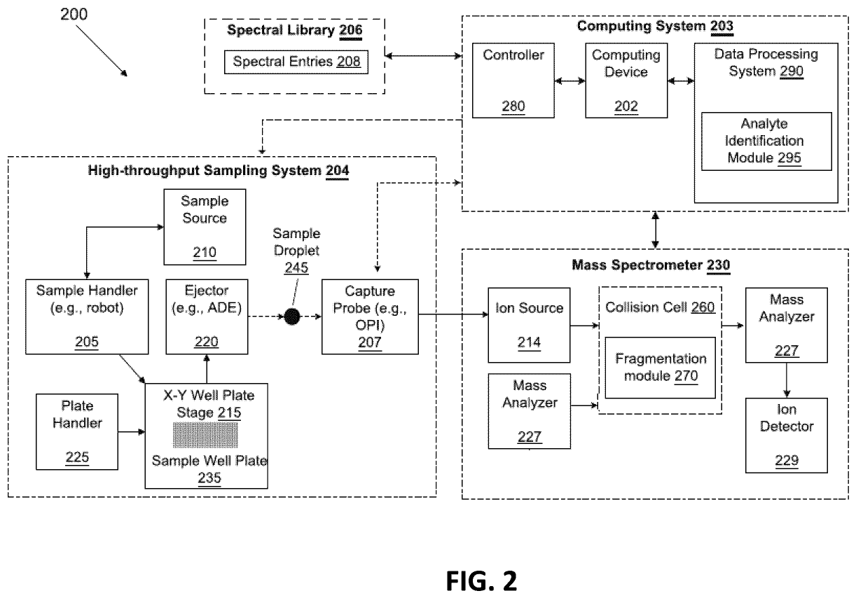

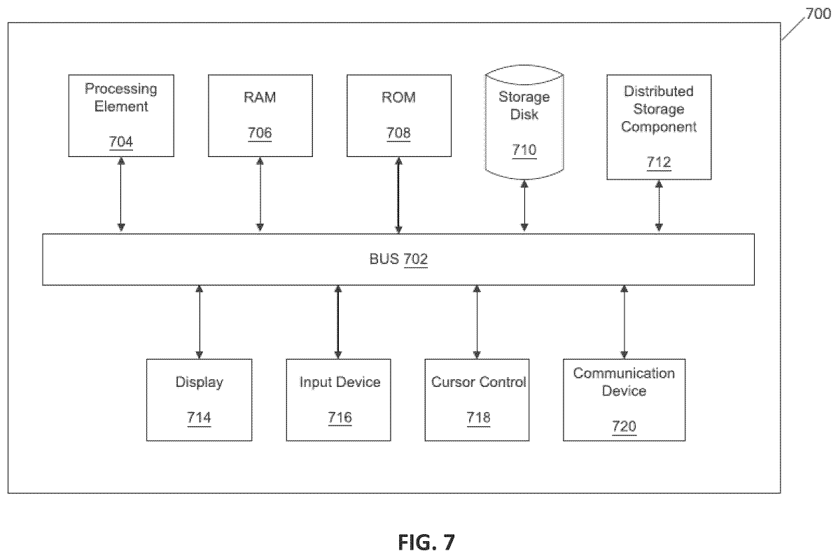

The system 100 includes an ADE 102 that is configured to generate acoustic ejection energy that is applied to a liquid contained within a reservoir 110 that causes one or more droplets or samples 108 to be ejected from the reservoir 110 into the open end of the sampling OPI 104. A controller 130 can be operatively coupled to and configured to operate any aspect of the system 100. This enables the acoustic transducer of the acoustic ejector 106 to inject droplets or samples 108 into the sampling OPI 104 as otherwise discussed herein substantially continuously, or for selected portions of an experimental protocol, by way of non-limiting example. Other types of sample introduction systems, such as gravity-based droplet systems may be utilized. ADE 102 and other non-contact ejection systems may be advantageous because of the high sample throughput that may be achieved. Controller 130 can be, but is not limited to, a microcontroller, a computer, a microprocessor, or any device capable of sending and receiving control signals and data, as described below with respect to the computing device illustrated in, e.g., FIG. 2 or FIG. 7. Wired or wireless connections between the controller 130 and the remaining elements of the system 100 are not depicted but would be apparent to a person of skill in the art.

As shown in FIG. 1, the ESI source 114 (when utilized) can include a source 136 of pressurized gas (e.g., nitrogen, air, or a noble gas) that supplies a high velocity nebulizing gas flow to the nebulizer nozzle 138 that surrounds the outlet tip of the electrospray electrode 116. As depicted, the electrospray electrode 116 protrudes from a distal end of the nebulizer nozzle 138. The pressured gas interacts with the liquid discharged from the electrospray electrode 116 to enhance the formation of the sample plume and the ion release within the plume for sampling by mass analyzer detector 120, e.g., via the interaction of the high-speed nebulizing flow and jet of liquid sample (e.g., analyte-solvent dilution). The liquid discharged may include liquid samples LS received from at least one reservoir 110 of the well plate 112. The liquid samples LS are diluted with the solvent S and typically separated from other samples by volumes of the solvent S (hence, as flow of the solvent S moves the liquid samples LS from the OPI 104 to the ESI source 114, the solvent S may also be referred to herein as a transport liquid). The nebulizer gas can be supplied at a variety of flow rates, for example, a flow rate in a range from about 0.1 L/min to about 40 L/min, which can also be controlled under the influence of controller 130 (e.g., via opening and/or closing valve 140).

It will be appreciated that the flow rate of the nebulizer gas can be adjusted (e.g., under the influence of controller 130) such that the flow rate of liquid within the sampling OPI 104 can be adjusted based, for example, on suction/aspiration force generated by the interaction of the nebulizer gas and the analyte-solvent dilution as it is being discharged from the electrospray electrode 116 (e.g., due to the Venturi effect/shock formation). The ionization chamber 118 can be maintained at atmospheric pressure, though in some examples, the ionization chamber 118 can be evacuated to a pressure lower than atmospheric pressure.

It will also be appreciated by a person skilled in the art and in light of the teachings herein that the mass analyzer detector 120 can have a variety of configurations. Generally, the mass analyzer detector 120 is configured to process (e.g., filter, sort, dissociate, detect, etc.) sample ions generated by the ESI source 114. By way of non-limiting example, the mass analyzer detector 120 can be a triple quadrupole mass spectrometer, or any other mass analyzer known in the art and modified in accordance with the teachings herein. Other non-limiting, exemplary mass spectrometer systems that can be modified in accordance with various aspects of the systems, devices, and methods disclosed herein can be found, for example, in an article entitled “Product ion scanning using a Q-q-Q linear ion trap (Q TRAP) mass spectrometer,” authored by James W. Hager and J. C. Yves Le Blanc and published in Rapid Communications in Mass Spectrometry (2003; 17:1056-1064); and U.S. Pat. No. 7,923,681, entitled “Collision Cell for Mass Spectrometer,” the disclosures of which are hereby incorporated by reference herein in their entireties.

Other configurations, including but not limited to those described herein and others known to those skilled in the art, can also be utilized in conjunction with the systems, devices, and methods disclosed herein. For instance, other suitable mass spectrometers include single quadrupole, triple quadrupole, ToF, trap, and hybrid analyzers. It will further be appreciated that any number of additional elements can be included in the system 100 including, for example, an ion mobility spectrometer (e.g., a differential mobility spectrometer) that may be disposed between the ionization chamber 118 and the mass analyzer detector 120 and configured to separate ions based on their mobility difference in high-field and low-field). Additionally, it will be appreciated that the mass analyzer detector 120 can comprise a detector that can detect the ions that pass through the analyzer detector 120 and can, for example, supply a signal indicative of the number of ions per second that are detected.

FIG. 2 is a schematic diagram illustrating the operation of an example system combining acoustic droplet ejection (ADE) with an open port interface (OPI) sampling interface and electrospray ionization (ESI) source. In the illustrated example, the system 200 is operative to perform, e.g., high-throughput mass spectrometry analysis. Similar to the system 100 of FIG. 1, the system 200 includes a sampling system 204, a MS 230, a computing system 203, and optionally a spectral library 206 that may include a plurality of spectral entries 208.

In various aspects, the sampling system 204 may include at least one of a sample source 210 (similar to the reservoir 110 or well plate 112 of FIG. 1), a sample handler 205, a capture probe 207, an X-Y well plate stage 215, an ejector 220, and a plate handler 225. The sample source 210 and the sample handler 205 are operative to retrieve collections of samples from the sample source 210 and to deliver the retrieved collections to capture locations associated with sample capture probe 207. The system 200 may be operative to independently capture selected ones of the plurality of samples at the capture locations, e.g., capture probe 207, to optionally dilute the samples and to transfer the captured samples to MS 230 for mass analysis. In some embodiments, the sample source 210 may include a set of well plates in a storage housing and/or liquid for adding to well plates 235. The sample source 210 may include part of a liquid handling system that manipulates and/or injects liquid into the well plates 235. The sample handler 205 includes one or more electro-mechanical devices (e.g., robotics, conveyor belts, stages, and the like) that are capable of transferring samples (e.g., well plates) from the sample source 210 to other components of the sampling system 204 and/or to other components, such as the ejector 220 and/or the capture probe 207. As an example, the sample handler 205 may transfer a sample well plate 235 to the ejector 220 or the plate handler 225.

In various aspects, the ejector 220 is operable to eject droplets of samples 245 from the wells of the well plate 235. The size of the droplet or sample may typically be from 1 to 25 nanoliters. The ejector 220 may be any type of suitable ejector, such as an acoustic ejector, a pneumatic ejector, or another type of contactless ejector. In an example, the plate handler 225 receives a well plate 235 from the sample handler 205. The plate handler 225 transports the well plate 235 to a capture location that may be aligned with the capture probe 207. Once in the capture location, the ejector 220 ejects droplets 245 from one or more wells of the well plate 235. The plate handler 225 may include one or more electro-mechanical devices, such as a translation stage 215 that translates the well plate 235 in an X-Y plane to align wells of the well plate 235 with the ejector 220 and/or or the capture probe 207.

In various aspects, the MS 230 includes at least one of an ion source (e.g., ionization source) 214, a mass analyzer 227, an ion detector 229, and a collision cell 260. The MS 230 can be operative, for example, through use of ion source(s) or generator(s) 214 to produce sample ions of the sample introduced into the MS 230. The collision cell 260 is operative to fragment the precursor ions produced by the ion source 214 to generate product ions (fragment ions) derived from the precursor ions. In various examples, the mass analyzer 227 may be before the collision cell. The MS 230 is further operative to filter and detect selected ions of interest from the sample ions through the use of the mass analyzer 227 and ion detector 229. The mass analyzer 227 is operative to analyze the sample ions and produce a mass spectrometry dataset comprising all ion current signals from the sample ions.

In some aspects, the MS 230 is operative to perform tandem mass spectrometry analysis through the use of the collision cell 260. The collision cell 260 may further include a fragmentation module 270 operative to apply an energy to the selected precursor ions and cause the selected precursor ions to undergo fragmentation and generate product ions. The fragmentation module 270 may include at least one of collision induced dissociation (CID), surface induced dissociation (SID), electron capture dissociation (ECD), electron transfer dissociation (ETD), metastable-atom bombardment, photo-fragmentation, or combinations thereof.

It will also be appreciated by a person skilled in the art and in light of the teachings herein that the mass analyzer 227 can have a variety of configurations. Generally, the mass analyzer 227 is operative to process (e.g., filter, sort, dissociate, detect, etc.) sample ions generated by the ion source 214. By way of non-limiting example, the mass analyzer 227 may be a triple quadrupole mass spectrometer, or any other mass analyzer known in the art and modified in accordance with the teachings herein.

In various aspects, the computing system 203 may include a computing device 202 as described above, a controller 280, and a data processing system 290. The controller 280 may be in the form of electronic signal processors and in electrical communication with other subsystems within the system 200. The controller 280 may be operative to coordinate some or all of the operations of the pluralities of the various components of the system 200. In one example, the controller 280 may be a controller for the mass spectrometer 227 and may be used as the primary controller for controlling components in addition to those components housed within the mass spectrometer 227. As such, the controller 280 may be considered the main or central controller that orchestrates, or communicates with, the other controllers to carry out the operations discussed herein in a more efficient manner.

In various aspects, the data processing system 290 may include various components and modules operative to process mass spectrometry data and to provide real-time feedback to users and other subsystems. In some embodiments, the data processing system 290 further includes an analyte identification module 295. The analyte identification module 295 may be operative to perform a library search and predict compound identity of a target analyte in a test sample, optionally through use of the trained machine learning algorithm. In various examples, the computing system 203 may be similar to the computing device 700 described in greater detail below with respect to FIG. 7.

In operation, the sampling system 204 (including sample source 210 and sample handler 205) can iteratively deliver independent samples from a plurality of sample sources (e.g., a droplet from a well of well plate 235) to the capture probe 207. The capture probe 207 can dilute and transport each such delivered sample to the MS 230 disposed downstream of the capture probe 207 for ionizing the diluted sample. The mass analyzer 227 can receive generated ions from the ion source 214 and/or the collision cell 260 for mass analysis. The mass analyzer 227 is operative to selectively separate ions of interest from generated ions received from the ion source 214 and to deliver the ions of interest to the ion detector 229 that generates a mass spectrometer signal indicative of detected ions to the computing system 203. In some aspects, the separate ions of interest may be indicated in an analysis instruction associated with that sample. In some aspects, the separate ions of interest may be indicated in an analysis instruction identified by an indicia physically associated with the plurality of samples.

The system 200 may include a commercial product such as, e.g., a Biomek computer available from Beckman Coulter Life Sciences, which is in operative communication with a MS 230 and a controller for the capture probe 207, which may include, for example, a SCIEX OS computer available from SCIEX. The SCIEX OS computer includes a control controller for the capture probe 207, represented for example by SCIEX open port interface software, and a controller for the MS 230, which may be the SCIEX OS computer. The MS 230 and the controller for capture probe 207 may be further in operative communication with an ejector 220 and an X-Y well plate stage 215, which may be, for example, a liquid droplet ejector with embedded computer or processor. For the purposes of this disclosure, these distributed controller components may collectively be considered to be a system controller, and depending upon the configuration, may be centralized or distributed as is the case here. For instance, one of the controllers or controller components may send signals to the other controllers to control the respective devices.

In one particular example, the high-throughput system 200 employs the ADE-OPI-MS technology. The ADE-OPI-MS system according to the present disclosure relies on acoustic dispensing of droplets directly from the wells of the plate or sample source under analysis. The acoustically dispensed droplets, which are typically at nanoliter scale, with precise control and independent of the sample solvent, are acoustically ejected from the ejected sample and introduced to a vortex at the opening of the OPI and delivered directly to the ionization source of the MS for detection. The substantially small samples required, coupled with the method's resilience in handling unpurified samples, make this technology advantageous for direct sampling from the well plate or sample source. The ADE-OPI-MS system and method also offer significant speed advantages: with an average analysis time of 1-2 seconds per sample and a small quantity of 1-10 nanoliter per sample, such that a typical well plate containing 384 wells can be analyzed in under 15 min. Thus, the ADE-OPI-MS system advantageously enables high-throughput analysis of a large quantity of samples and generate a large volume of data within a meaning time frame such as a day. In addition, the ADE-OPI is compatible with both nominal and high-resolution mass spectrometers, allowing rapid quantification with the former, and extensive analyte identification with the latter. It should be noted that although the MS 230 is discussed herein, principles of the above embodiments may be applicable to any other mass analyzing device, or to any sample detection device.

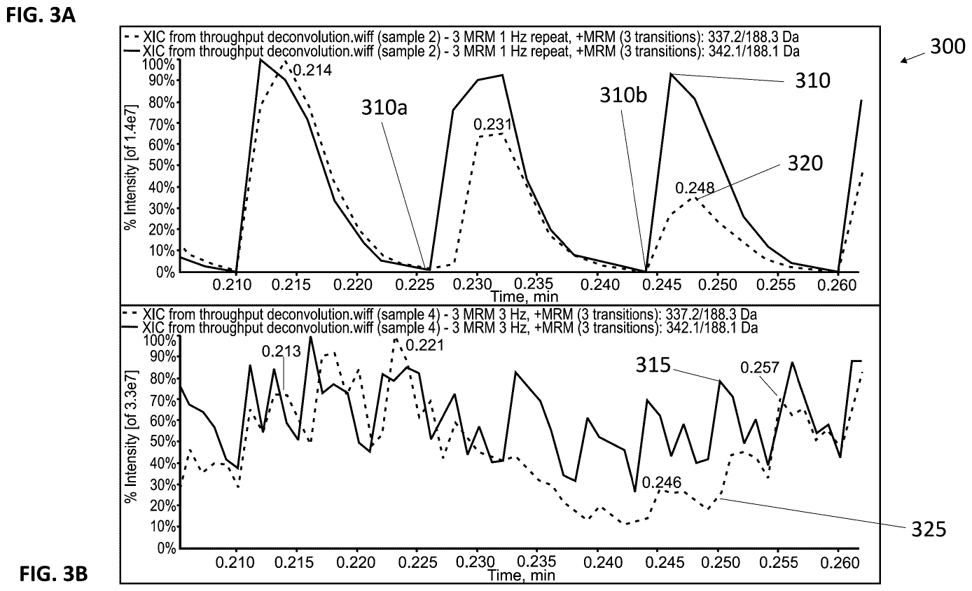

FIGS. 3A and 3B depict profiles of different frequencies of sample introduction in the mass analyzer, according to various examples of the disclosure. FIG. 3A illustrates an example of data acquisition at a throughput frequency of 1 Hz, the sample including a target analyte and a single internal standard. In FIG. 3A, the trace 310 corresponds to a known internal standard, e.g., an analyte that is known and for which the sampling timing and intensity are known and expected. In examples, the trace 320 corresponds to the unknown analyte, or target analyte. In various examples, at a throughput frequency of 1 Hz, the trace 310 of a single internal standard is sufficiently baseline-separated, as indicated by the clear indication of the start time 310a and end time 310b. In other examples, the throughput frequency may be greater than 1 Hz such as, e.g., up to 3 Hz or greater, and the signal peak width may as a result be different than what is represented in FIG. 3A. As such, the trace 310 of a single internal standard may be sufficient to establish a sampling timing of the unknown analyte, as well as establish a sufficient baseline separation.

FIG. 3B illustrates an example of a data acquisition at a throughput frequency of 3 Hz acquisition, also with a single internal standard. In FIG. 3B, the trace 315 corresponds to the known internal standard, and the trace 325 corresponds to the target analyte. In examples, due to the higher throughput frequency, the trace of the internal standard 315 is not sufficient to provide a useful sampling timeline for the unknown analyte, e.g., clear baseline-separated features (such as the start time 310a and end time 310b of FIG. 3A) are not apparent in FIG. 3B. In examples, the trace of the internal standard 315 is also not sufficient to provide useful baseline separation that could be used to clearly identify the peaks of the trace 325 of the target analyte. Specifically, FIG. 3B shows highly overlapping peaks in both traces 315 and 325, which results in a decreasing number of sampling points that may correspond predominantly to a single peak, and thus render the deconvolution of the peaks of the trace 325 of the unknown sample more challenging.

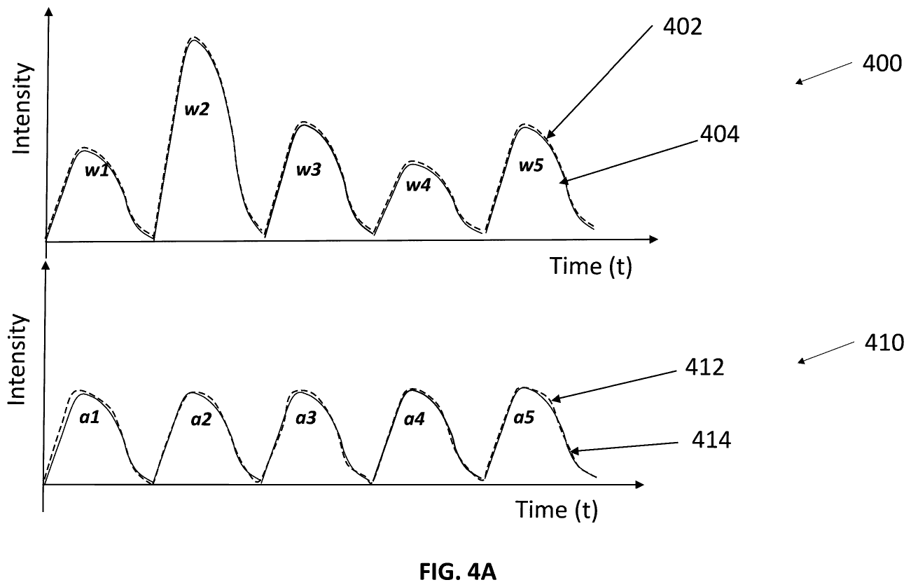

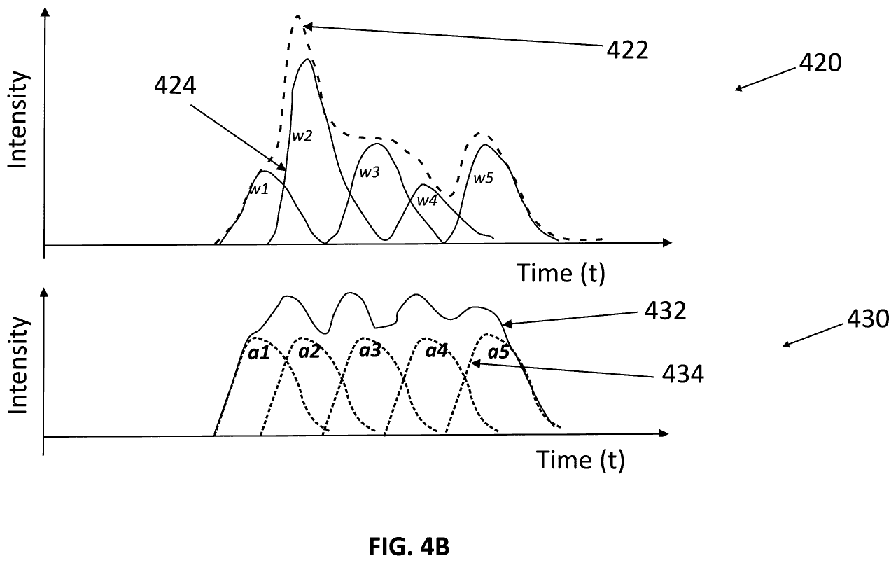

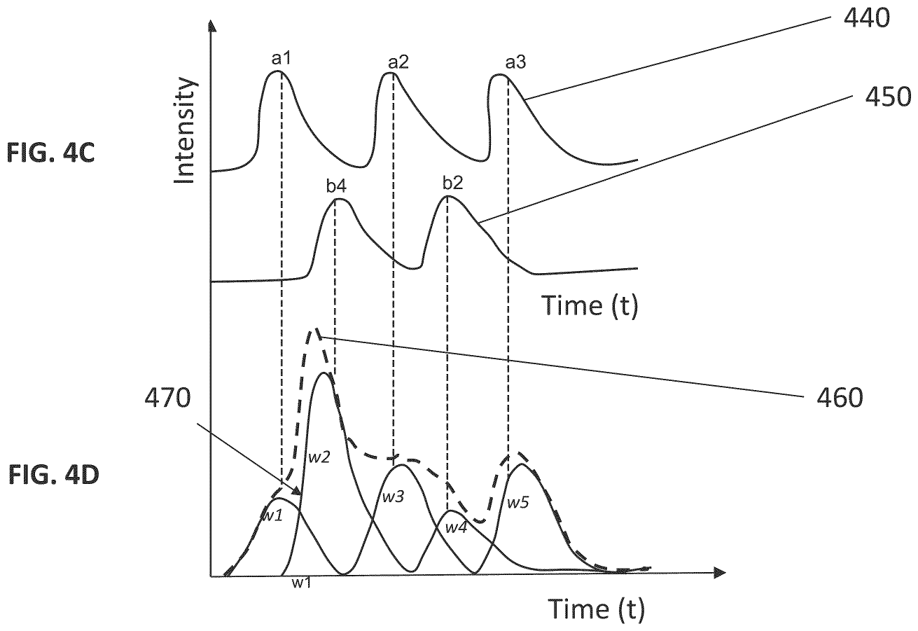

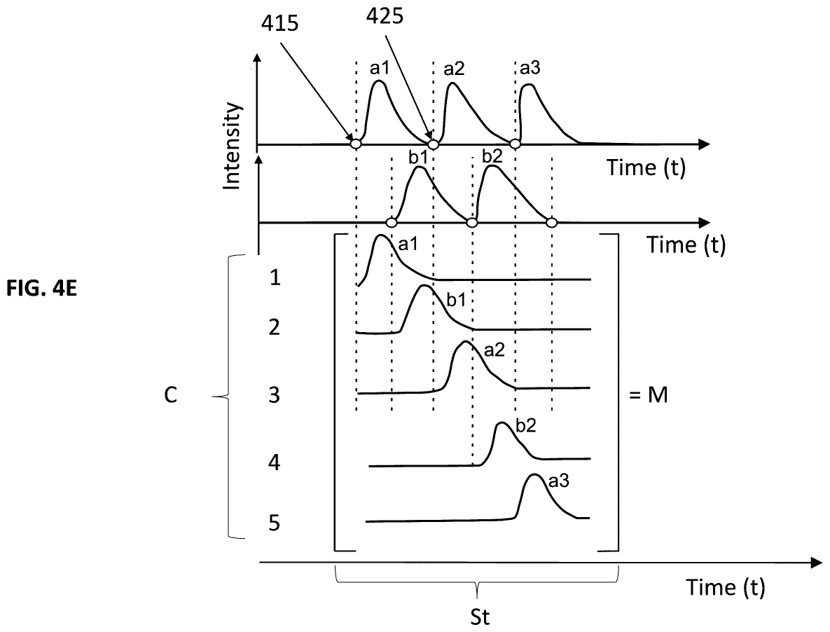

FIGS. 4A-4F depict low-throughput and high-throughput data acquisition traces with internal standards, in accordance with various examples of this disclosure. In conventional, e.g., low throughput, methods, where the trace 400 is illustrated in the upper portion of FIG. 4A, low throughput methods have a low ejection frequency e.g., lower than 1 Hz, and the low ejection frequency generally results in well time-separated sample signals, as clearly illustrated in FIG. 4A. In the case of sufficiently time-separated signals, the target analyte peaks are sufficiently baseline-separated. For example, the upper portion of FIG. 4A illustrates the signal trace 400 of a target analyte collected from a plurality of wells labeled “wi” where “i” ranges from 1 to 5, and represents the signals measured for five (5) different wells w1-w5. The dashed-line trace 402 represents the combined trace of all the wells. The solid-line trace 404 represents each individual trace signal corresponding to each individual well w1-w5. In this case, because the peaks for the target analyte present in wells w1-w5 are well-separated due to the low throughput frequency of data acquisition, the dashed-line trace 402 is substantially coincident or conform to the solid-line trace 404.

In various examples, trace 410, in the lower portion of FIG. 4A, represents an internal standard “ai” added to each well “wi,” where “i” is from 1 to 5. The internal standard here may be, e.g., a known analyte. The resulting trace 410 of the internal standard is measured, as illustrated in the bottom portion of FIG. 4A. In trace 410, the contribution from the internal standard “ai” in each well “i” is measured as part of the signal trace 410. In the trace 410, the dashed-line trace 412 represents the combined contribution of all the standards a1-a5 to the signal trace 410, and the straight-line trace 414 represents the individual signal trace of each of the standards a1-a5. In this case, because the peaks are well-separated due to the low throughput frequency of data acquisition, the dashed-line trace 412 is substantially coincident or conform to the straight-line trace 414. Accordingly, FIG. 4A shows that at low throughput frequencies, the use of an internal standard may not yield any appreciable advantages because the trace of the unknown analyte is typically sufficiently baseline-separated.

FIG. 4B illustrates a high-throughput or high-frequency data acquisition trace for both the trace 420 of an unknown target analyte and the trace 430 for an internal standard which is a known analyte. For example, the high-throughput data acquisition may be performed at a frequency of 1 Hz or greater, including a range of frequencies of 1 Hz to 3 Hz or higher, or a frequency of 2.5 Hz or greater. For trace 420 in the upper portion of FIG. 4B, the high-throughput data collection results in sample signals that overlap in time. Specifically, the dashed-line trace 422 represents the combined contribution of all the wells w1-w5, each well including the target analyte. The straight-line trace 424 represents the individual signal of each well w1-w5, and clearly shows that the signals from each individual well w1-w5 overlap in time. As such, analyzing the target analyte is challenging because at any point in time, the measured signal 422 is the sum of signals from multiple neighboring wells. For example, analyzing the target analyte for each well include calculating the area under each peak “wi.” The overlay of traces 422 and 424 illustrated in FIG. 4B shows that there is less coincidence between the traces 422 and 424 when compared to the coincidence between traces 402 and 404 for the low throughput frequency data collection illustrated in FIG. 4A. The lack of coincidence between the combined trace 422 and the individual traces 424 is due to the poor baseline separation between each peak corresponding to each individual well “wi” such that, at any given time “t,” the overall signal is rarely, seldom or never, the signal of a single well but is instead the combination or the addition of the signals from two or more different wells. Accordingly, it may be challenging to analyze the target analyte because the individual peaks w1-w5 are not sufficiently deconvoluted or baseline separated.

In various examples, trace 430 represents an internal standard “ai” added to each well “wi.” Similarly to the trace of the target analyte 420, the trace of the internal standard 430 includes the combined trace 432 for all of the peaks a1-a5 corresponding to the internal standard added to the sample in the wells w1-w5. In examples, the combined trace 432 shows that individual peaks 434, each being representative of the internal standard “ai” in a single well “wi,” are not sufficiently deconvoluted or baseline-separated. The overlay of traces 432 and 434 shows that there is little coincidence therebetween. The lack of coincidence between the combined trace 432 and the individual traces 434 of the internal standard “ai” added to each well is due to the poor baseline separation between each peak “ai” corresponding to the individual wells such that, at any given time t, the overall signal is rarely, seldom or never, the signal of the internal standard of a single well, but is instead the combination or addition of the signals of internal standards from two or more different wells. Accordingly, it may be challenging to use a single internal standard to identify the target analyte because the individual peaks are not sufficiently deconvoluted or separated.

In various examples, the challenge of peak overlap, which renders the calculation of the amount of target analyte in each sample challenging. Accordingly, an advantage according to an aspect of the present disclosure includes the use of more than one internal standard. For example, more than one internal standard may be added to one or more samples of the sample plate. In an example, while one internal standard is added to each sample of the sample plate, another different internal standard may be added to each other sample of the sample plate. Other alternating patterns may also be used.

FIG. 4C illustrates a low-throughput or low-frequency data acquisition trace for two (2) internal standard traces 440 and 450. According to various examples, using two or more different internal standards may allow to better analyze a target analyte. In examples, the trace 440 illustrates the signal intensity measured from a plurality of wells, e.g., three (3) wells, for a first internal standard. Trace 440 illustrates peaks al, a2 and a3 corresponding to the first internal standard being ejected from three different wells. In examples, the three different wells may be adjacent wells, or intercalated wells, on the well plate. In other examples, trace 450 illustrates the signal intensity measured from two (2) wells for a second internal standard. For example, the second internal standard may be different from the first internal standard. Trace 450 illustrates peaks b1 and b2 corresponding to the second internal standard being added to two different wells. In various examples, based on the location of each peak on the time axis, the wells corresponding to peaks a1-a3 of the trace 440 of the first internal standard are alternated with the wells corresponding to peaks b1 and b2 of the trace 450. In both traces 440 and 450, the peaks are sufficiently time-separated with no overlap therebetween, and calculating the area under each peak, to determine the concentration or amount of the standards in each well, is straightforward due to the lack of any overlap with neighboring peaks.

In various examples, FIG. 4D illustrates a high-throughput or high-frequency data acquisition trace 460 of a target analyte received from a plurality of wells w1-w5, and the combined trace 470 of the target analyte for each well w1-w5. In FIG. 4D, the samples of target analyte are located in the same wells as both the first internal standard and the second internal standard illustrated in FIG. 4C. However, instead of the well time-separated peaks a1-a3 or b1-b2 shown in FIG. 4C, peaks 470 representing samples w1-w5 show a significant amount of overlap therebetween. Also, the combined trace 460 shows little coincidence with any of the peaks 470. Accordingly, when analyzing the combined trace 460, it may be challenging to determine the number of peaks that make up the combined trace 460. It may also be challenging to determine where each individual peak 470 is located on the time scale so as to correlate the peaks 470 to individual wells in the well plate. In addition, without having two internal standards as illustrated in FIG. 4C, it may be challenging to determine the concentration or amount of each of the samples w1-w5 corresponding to each peak 470 because it is difficult to calculate the intensity or area under each peak 470.

In various examples of the present disclosure, FIG. 4E illustrated the use of the two internal standards illustrated in FIG. 4C to analyze the trace of the target analyte illustrated in FIG. 4D. In examples, due to the use of the two internal standards, instead of creating a theoretical peak shape and using numerical optimization for analyte signal deconvolution, the measured internal standard signal can be used directly without modeling of the peak shape. For example, internal standard signals a (a1, a2 and a3) and b (b1 and b2) can be sectioned between start point 415 and end point 425 of each individual well peak. For example, the measured signal intensities may be placed in a “basis matrix” M where each row Cᵢ of the basis matrix M corresponds to an individual well, and each column Sₜᵢ of the matrix M is a measurement time point index such as, e.g., start point 415 and end point 425. For example, each row Cᵢ has a non-zero intensity only between the start and stop time index correspond to start point 415 and end point 425 for each corresponding well, and the intensities are equal to the measured signal for the internal standard signal of the corresponding well. Using a non-negative least squares (NNLS) method, the unknown quantity of the target analyte in each well may then be determined by solving the following equation:

C*M=S Equation (1)

In Equation (1) above, C is the row vector of target analyte quantities, which are the peak areas, and is equal to C=[c1 c2 . . . c5], and S is the column vector of measured analyte signal at each time point t, S=[Sₜ₁ Sₜ₂ Sₜ₃ . . . Sₜₙ] . Accordingly, the amount of unknown analyte in each well may be determined without numerically modeling the combined peak as is conventionally done.

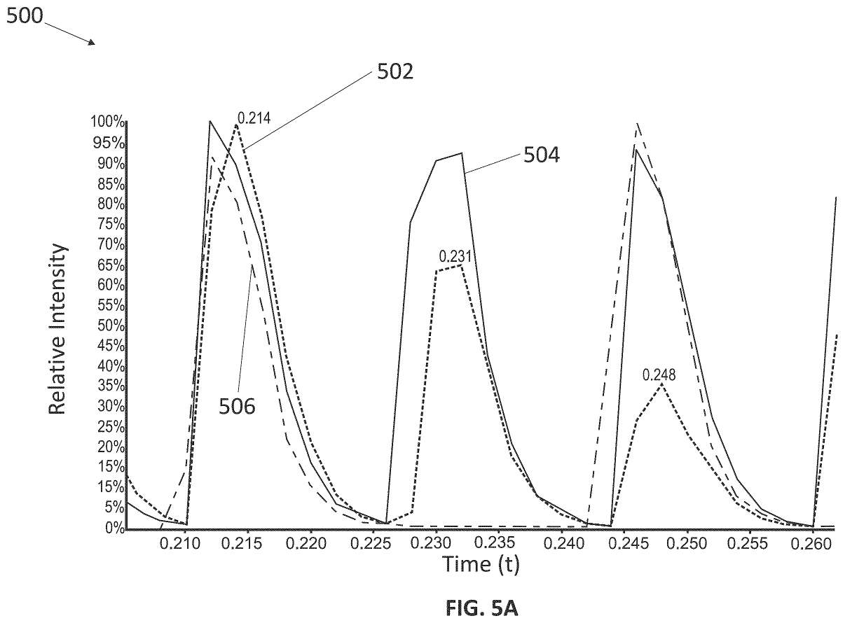

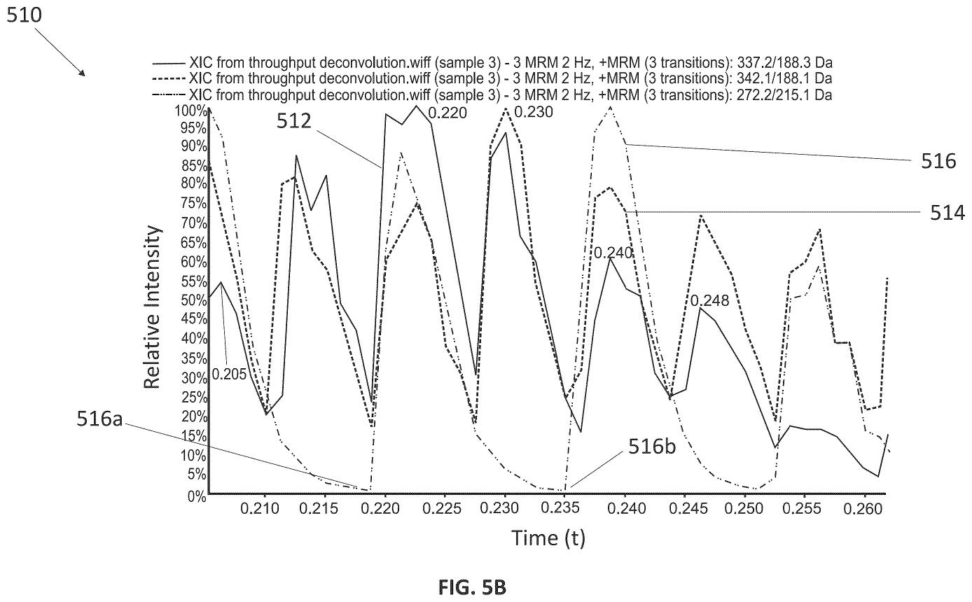

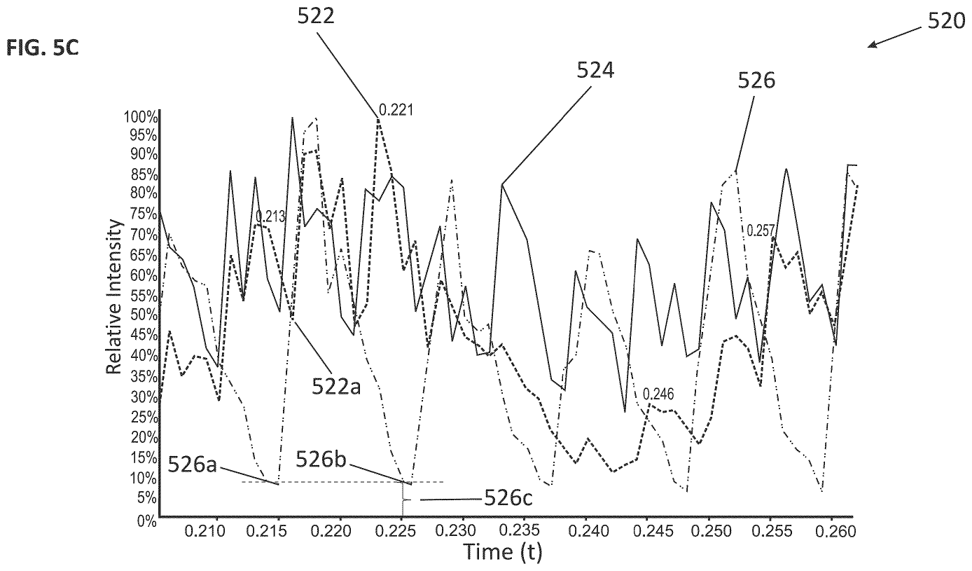

FIGS. 5A-5C illustrate data acquisition traces with internal standards at various throughput frequencies, according to various examples of the disclosure. FIGS. 5A, 5B and 5C replicate sample acquisitions at throughputs of 1 Hz, 2 Hz and 3 Hz, respectively. FIG. 5A is a graph 500 illustrating extracted ion chromatograms (XIC), or traces 502, 504 and 506, for a 1 Hz ejection throughput for three different types of analytes. For example, trace 502 is for the target analyte, trace 504 is for the first internal standard, and trace 506 is for the second internal standard. In examples, all three traces 502, 504 and 506 illustrated in FIG. 5A exhibit peaks that are sufficiently baseline-separated, and that can be easily integrated to determine the amount of the target analyte in each sample well.

In FIG. 5B, which corresponds to a throughput frequency of 2 Hz, graph 510 illustrates trace 512 for the target analyte, and traces 514 and 516 for the first and second internal standard, respectively. In various examples, trace 514 for the first internal standard, which is present in each well, shows baseline-unresolved peaks at this throughput frequency. In various examples, trace 514 may be used to determine an amount of interference from the peak of trace 512 for the target analyte from one well to the peak of trace 512 from the neighboring well. Trace 516 shows the second internal standard, which is present in every second well, and trace 516 clearly shows peaks that are sufficiently baseline-separated. For example, the trace 516 shows well-defined start points 516a and end points 516b for each peak of the trace 516. In various examples, the sufficiently baseline-separated peaks of trace 516 may be used as reference points in time from which to identify and analyze the peaks of the trace 512 of the target analyte. In other examples, by providing a clear indication of the signal-to-noise at the lowest point of the peaks such as, e.g., 516a and 516b, the trace 516 may also be used to calculate the intensity of the peak of the target analyte in a given well based on the known intensity of the peak of the first internal standard 514 for the same given well.

In FIG. 5C, which corresponds to a 3 Hz ejection throughput, shows that the peaks of trace 526, which correspond to the second internal standard, starts to partially overlap but are still relatively easy to deconvolute, while the trace 522 for the target analyte and the trace 524 for the first internal standard have a high degree of overlap. Accordingly, the trace 522 for the target analyte and the trace 524 for the first internal standard have relatively high degrees of uncertainty with respect to the actual peak positions and their intensities. In FIG. 5C, the deconvoluted trace 526 for the second internal standard may be used to assist in the quantitative deconvolution of traces 522 and 524. For example, the trace 526 shows well-defined start points 526a and end points 526b for each peak of the trace 526. Accordingly, as the peaks 526 are generally sufficiently baseline-separated and the second internal standard is not present in every sample or well of the well plate, the peaks 526 may be used as a reference for the detection of the start time and end time of the signal corresponding to the target analyte, namely the peaks of trace 522. For example, start time 522a of the target analyte may be accurately estimated based on the known start time 526a of the second internal standard. As such, the use of a time log to associate individual peaks with the corresponding samples may no longer be necessary in order to identify and analyze the target analyte.

In various examples, the distance or signal intensity gap 526c between the start/end points 526a/526b and the bottom of the intensity axis may be interpreted to correspond to signal noise. Accordingly, the presence of the second internal standard trace 526 provides an additional useful advantage in allowing to estimate the signal noise so as to account for signal noise when calculating the peak intensity of the target analyte in trace 522 and the peak intensity of the first internal standard in trace 524. For example, the peak intensity of both the first internal standard and the target analyte may be measured with respect to the lowest point of the peaks of trace 526, namely from the gap 526c, instead of from the point of zero intensity. Accordingly, it may be possible to more accurately determine the peak intensities by eliminating the contribution from signal noise.

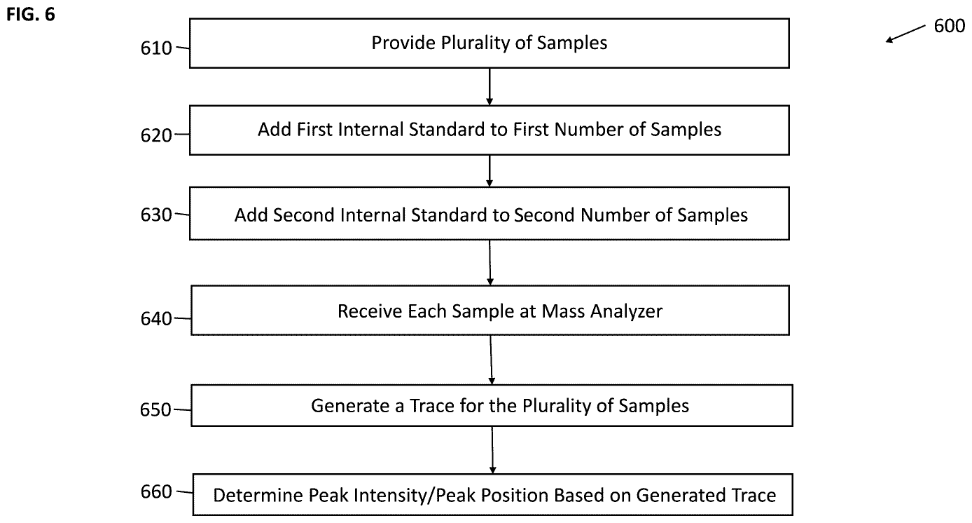

FIG. 6 is a flow chart depicting an example method 600 for operating a high-throughput mass analyzer using internal standards, in accordance with various examples of the disclosure. For the sole purpose of convenience, method 600 is described through use of the example systems 100 or 200 described above. However, it is appreciated that the method 600 may be performed by any suitable system such as, e.g., MALDI, DESI, EI, rapid-fire mass spectrometry, or other ionization techniques or devices.

In various examples, operation 610 includes providing a plurality of samples. For example, operation 610 includes providing each one of the plurality of samples in a well of a well plate. For example, the well plate may include 384 wells, or 1536 wells. In examples, a position of each well in the well plate is known, therefore the position of each sample in the wells of the well plate is also known.

In various examples, operation 620 includes adding a first internal standard to a first predetermined number of samples, the first internal standard including a first known analyte. For example, the first internal standard may be added to each sample that includes the target analyte. In other examples, the first internal standard may be added in a first predetermined pattern of samples such as, e.g., every other sample, every third sample, or any other desired distribution or pattern of samples. For example, the first predetermined pattern corresponds to the first predetermined number of samples. In another example, the first internal standard has a known intensity at a given time, has a known mass-to-charge ratio as well as a known intensity for a given mass-to-charge ratio.

In various examples, operation 630 includes adding a second internal standard in a second predetermined number of samples in addition to the target analyte, the second internal standard including a second known analyte. In an example, the second internal standard has a known intensity at a given time, has a known mass-to-charge ratio as well as a known intensity for a given mass-to-charge ratio. For example, the second internal standard may be different than the first internal standard. In other examples, the second predetermined number of samples may be the same or different from the first predetermined number of samples. In other examples, the second internal standard may be added in a second predetermined pattern of samples such as, e.g., every other sample, every third sample, or any other desired distribution or pattern of samples. For example, the second predetermined pattern corresponds to the second predetermined number of samples. In another example, the first predetermined pattern is different from the second predetermined pattern. In yet another example, the first predetermined pattern and the second predetermined pattern overlap, e.g., at least one sample of the plurality of samples may include both the first internal standard and the second internal standard in addition to the target analyte. In other examples, some of the samples include both the first internal standard and the target analyte, but not the second internal standard. In further examples, some of the samples include the first internal standard, the second internal standard and the target analyte. In further examples, when each of the plurality of samples are in a well of a well plate, the first internal standard and/or the second internal standard are added to regularly spaced wells of the well plate.

In other examples of the above aspect, operation 630 may also include adding a third internal standard in some of the samples, the third internal standard including a known analyte. For example, the third internal standard has a known intensity at a given time, has a known mass-to-charge ratio as well as a known intensity for a given mass-to-charge ratio. In additional examples, the third internal standard may be added to a third predetermined number of wells, and may be added according to a third predetermined pattern of samples. In another example, the first internal standard, the second internal standard and the third standard may be added to alternating wells of the plurality of wells.

In various examples, operation 640 includes receiving each sample, which includes the target analyte as well as a combination of the first internal standard, the second internal standard, and so on, at the mass analyzer. In various examples, the samples may be received at the mass analyzer via ejection, and the term “ejection” may refer to an actual ejection as well as to any other form or receiving a sample from a sample source such as, e.g.,. wells of a well plate. For example, the well plate may have 384 wells or 1536 wells. In various examples, operation 640 may be performed by, e.g., a sample analyzing system that includes, e.g., an acoustic ejector, an ionization chamber, and/or a mass spectrometer. Other sample receivers and ionization devices that may be utilized are described herein. In examples, the acoustic ejector may be a non-contact sample ejector such as, e.g., an acoustic droplet ejector, and operation 640 may include receiving each sample by introducing, with the non-contact sample ejector, each sample from the well plate into the sample receiver. In various ejections, operation 640 includes receiving the samples at a frequency that is greater than 1 Hz, or, e.g., in a range of 1 Hz to 3 Hz.

In additional examples, operation 650 includes generating a trace for the plurality of samples. For example, operation 650 includes generating the trace for the plurality of samples by generating a single combined trace for all of the plurality of samples. In yet other examples, operation 650 includes generating the trace by detecting a plurality of signals, each signal comprising a peak position and peak intensity of the target analyte and at least one of a peak position and peak intensity of the first internal standard and a peak position and peak intensity of the second internal standard.

In various other examples, operation 660 includes determining a peak intensity and/or a peak position for the target analyte based on the trace generated during operation 650. For example, operation 660 includes determining the peak intensity for the target analyte by comparing the peak intensity of the target analyte for a given sample to a peak intensity of the first internal standard present in the same given sample. For example, comparing the peak intensity of the target analyte to the peak intensity of the first internal standard present in the given sample may be performed during operation 660 by determining the peak intensity for the first internal standard, determining the ratio of the peak height of the target analyte and the peak height of the first internal standard for the same sample, and determining the peak intensity for the target analyte based on the determined ratio and the determined peak intensity for the first internal standard. For example, if the peak intensity of the first internal standard is equal to 100 units, and the ratio of the peak intensity of the target analyte to the peak intensity of the first internal standard is equal to 0.8, then the peak intensity of the target analyte can be calculated as (0.8×100 =) 80 units.

In other examples, operation 660 includes determining the ratio of the peak height of the target analyte and the peak height of the first internal standard by determining a baseline of the peak of the second internal standard, and calculating the ratio of the peak height of the target analyte and the peak height of the first internal standard using the baseline of the peak of the second internal standard as a reference point. For example, with reference to FIG. 5C, the baseline of the second internal standard 526c can be taken into account when determining the ratio of the peak of the target analyte to the peak of the first internal standard. For example, the value of the gap 526c may be subtracted from the peaks in trace 522 and trace 526 in order to more accurately determine the ratio of the intensity of the peak in trace 522 to the peak in trace 524.

In various other examples, operation 660 also includes determining the peak position for the target analyte based on the generated trace by determining a start time for a peak of the second internal standard, and determining the peak position of the target analyte as a relative position of the peak with respect to the determined start time for the peak of the second internal standard. For example, the start time of the peak of the target analyte may be determined to be the same as the identified start time of the peak of the second internal standard. With reference to FIG. 5C, the start time of the second internal standard is referred to as 526a. In other examples, various operational parameters of the mass analyzer such as, e.g., mass analyzer 100 illustrated in FIG. 1, may be modified or optimized based on the determined start and end times, as well as the baseline, of the peaks of the second internal standard illustrated in trac 526.

FIG. 7 depicts a block diagram of a computing device similar to the computing device 202 discussed above with respect to FIG. 2. In the illustrated example, the computing device 700 may include a bus 702 or other communication mechanism of similar function for communicating information, and at least one processing element 704 (collectively referred to as processing element 704) coupled with bus 702 for processing information. As will be appreciated by those skilled in the art, the processing element 704 may include a plurality of processing elements or cores, which may be packaged as a single processor or in a distributed arrangement. Furthermore, a plurality of virtual processing elements 704 may be included in the computing device 700 to provide the control or management operations for, e.g., the mass analysis systems 100 and 200 illustrated above.

The computing device 700 may also include one or more volatile memory(ies) 706, which can for example include random access memory(ies) (RAM) or other dynamic memory component(s), coupled to one or more busses 702 for use by the at least one processing element 704. Computing device 700 may further include static, non-volatile memory(ies) 708, such as read only memory (ROM) or other static memory components, coupled to busses 702 for storing information and instructions for use by the at least one processing element 704. A storage component 710, such as a storage disk or storage memory, may be provided for storing information and instructions for use by the at least one processing element 704. As will be appreciated, the computing device 700 may include a distributed storage component 712, such as a networked disk or other storage resource available to the computing device 700.

The computing device 700 may be coupled to one or more displays 714 for displaying information to a user. Optional user input device(s) 716, such as a keyboard and/or touchscreen, may be coupled to Bus 702 for communicating information and command selections to the at least one processing element 704. An optional cursor control or graphical input device 718, such as a mouse, a trackball or cursor direction keys for communicating graphical user interface information and command selections to the at least one processing element. The computing device 700 may further include an input/output (I/O) component, such as a serial connection, digital connection, network connection, or other input/output component for allowing intercommunication with other computing components and the various components of, e.g., the mass analysis systems 100 and 200 discussed above.

In various embodiments, computing device 700 can be connected to one or more other computer systems via a network to form a networked system. Such networks can for example include one or more private networks or public networks, such as the Internet. In the networked system, one or more computer systems can store and serve the data to other computer systems. The one or more computer systems that store and serve the data can be referred to as servers or the cloud in a cloud computing scenario. The one or more computer systems can include one or more web servers, for example. The other computer systems that send and receive data to and from the servers or the cloud can be referred to as client or cloud devices, for example. Various operations of, e.g., the mass analysis systems 100 and 200 may be supported by operation of the distributed computing systems.

The computing device 202 discussed above with respect to FIG. 2, similar to the computing device 700, may be operative to control operation of the components of the mass analysis system 200 and the sampling system 204 through a communication device such as, e.g., communication device 720, and to handle data generated by components of the mass analysis system 200 through the data processing system 200. In some examples, analysis results are provided by the computing device 700 in response to the at least one processing element 704 executing instructions contained in memory 706 or 708 and performing operations on data received from the mass analysis system 200. Execution of instructions contained in memory 706 and/or 708 by the at least one processing element 704 can render, e.g., the mass analysis systems 100 and 200 and associated sample delivery components operative to perform methods described herein.

The term “computer-readable medium” as used herein refers to any media that participates in providing instructions to the processing element 704 for execution. Such a medium may take many forms, including but not limited to, non-volatile media, volatile media, and transmission media. Non-volatile media includes, for example, optical or magnetic disks, such as disk storage 710. Volatile media includes dynamic memory, such as memory 706. Transmission media includes coaxial cables, copper wire, and fiber optics, including the wires that include bus 702.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to the processing element 704 for execution. For example, the instructions may initially be carried on the magnetic disk of a remote computer. The remote computer can load the instructions into its dynamic memory and send the instructions over a telephone line using a modem. A modem local to computing device 700 can receive the data on the telephone line and use an infra-red transmitter to convert the data to an infra-red signal. An infra-red detector coupled to bus 702 can receive the data carried in the infra-red signal and place the data on bus 702. Bus 702 carries the data to memory 706, from which the processing element 704 retrieves and executes the instructions. The instructions received by memory 706 and/or memory 708 may optionally be stored on storage device 710 either before or after execution by the processing element 704.

In accordance with various embodiments, instructions operative to be executed by a processing element to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

This disclosure described some examples of the present technology with reference to the accompanying drawings, in which only some of the possible examples were shown. Other aspects can, however, be embodied in many different forms and should not be construed as limited to the examples set forth herein. Rather, these examples were provided so that this disclosure was thorough and complete and fully conveyed the scope of the possible examples to those skilled in the art.

Although specific examples were described herein, the scope of the technology is not limited to those specific examples. One skilled in the art will recognize other examples or improvements that are within the scope of the present technology. Therefore, the specific structure, acts, or media are disclosed only as illustrative examples. Examples according to the technology may also combine elements or components of those that are disclosed in general but not expressly exemplified in combination, unless otherwise stated herein. The scope of the technology is defined by the following claims and any equivalents therein.

What is claimed is:

1. A method of data acquisition for a mass analyzer, the method comprising:
providing a plurality of samples, each sample comprising a target analyte;
adding a first internal standard to a first predetermined number of samples, the first internal standard including a first known analyte;
adding a second internal standard to a second predetermined number of samples, the second internal standard comprising a second known analyte, the second internal standard being different than the first internal standard;
receiving each sample at the mass analyzer;
generating a trace for the plurality of samples; and
determining at least one of a peak intensity and a peak position for the target analyte based on the generated trace.

2. The method of claim 1, wherein providing the plurality of samples comprises providing each one of the plurality of samples in a well of a well plate.

3. The method of claim 1 wherein each of the first internal standard and the second internal standard has a known intensity at a given time, and has a known intensity for a given mass-to-charge ratio.

4. The method of claim 1, wherein the first predetermined number of samples is different from the second predetermined number of samples.

5. The method of claim 1, wherein adding the first internal standard comprises adding the first internal standard in a first predetermined pattern of samples corresponding to the first predetermined number of samples.

6. The method of claim 5, wherein adding the second internal standard comprises adding the second internal standard in a second predetermined pattern of samples corresponding to the second predetermined number of samples.

7. The method of claim 6, wherein the first predetermined pattern is different from the second predetermined pattern.

8. (canceled)

9. The method of claim 1, wherein at least one of the plurality of samples comprises the target analyte and the first internal standard.

10. The method of claim 1, wherein each one of the plurality of samples comprises the target analyte and the first internal standard.

11. The method of claim 1, wherein at least one of the plurality of samples comprises the target analyte, the first internal standard and the second internal standard.

12. The method of claim 1, wherein generating the trace for the plurality of samples comprises generating a single combined trace for the plurality of samples.

13. The method of claim 1, wherein generating the trace comprises detecting a plurality of signals, each signal comprising a peak position and peak intensity of the target analyte and at least one of a peak position and peak intensity of the first internal standard and a peak position and peak intensity of the second internal standard.

14. The method of claim 1, wherein determining the peak intensity for the target analyte based on the generated trace comprises comparing the peak intensity of the target analyte for a given sample to a peak intensity of the first internal standard present in the given sample.

15. The method of claim 14, wherein comparing the peak intensity of the target analyte for the given sample to the peak intensity of the first internal standard present in the given sample comprises:
determining a peak intensity for the first internal standard;
determining a ratio of a peak height of the target analyte and a peak height of the first internal standard; and
determining the peak intensity for the target analyte based on the determined ratio and the determined peak intensity for the first internal standard.

16. The method of claim 15, wherein determining the ratio of the peak height of the target analyte and the peak height of the first internal standard comprises:
determining a baseline of the peak of the second internal standard; and
calculating the ratio of the peak height of the target analyte and the peak height of the first internal standard using the baseline of the peak of the second internal standard as a reference point.

17. The method of claim 1, wherein determining the peak position for the target analyte based on the generated trace comprises:
determining a start time for a peak of the second internal standard; and
determining the peak position of the target analyte as a relative position of the peak with respect to the determined start time for the peak of the second internal standard.

18. The method of claim 17, further comprising adjusting one or more operating parameters of the mass analyzer based on the start time of the peak of the second internal standard.

19. The method of claim 1, wherein:
providing plurality of samples comprises providing each of the plurality of samples in a well of a well plate; and
adding the second internal standard comprises adding the second internal standard to regularly spaced wells of the well plate.

20. The method of claim 19, further comprising adding a third internal standard in a third predetermined number of wells of the well plate, the third standard comprising a third known analyte.

21. The method of claim 20, wherein the first internal standard, the second internal standard and the third standard are added to alternating wells of the plurality of wells.

22-50. (canceled)
